(19) United States
(12) Patent Application Publication
(10) Pub. No.: US 2012/0166101 A1
(43) Pub. Date: Jun. 28, 2012

(54) CHROMATOGRAPHIC PEAK IDENTIFICATION USING BOOTSTRAP REPLICATION OBJECT ORIENTED SYSTEM AND METHOD

(76) Inventor: Fred E. Lytle, Indianapolis, IN (US)

(21) Appl. No.: 13/336,173

(22) Filed: Dec. 23, 2011

Related U.S. Application Data
(60) Provisional application No. 61/427,012, filed on Dec. 23, 2010.

(51) Int. Cl. G06F 19/00

(52) U.S. Cl. 702/32

(57) ABSTRACT

A computerized system and method analyzes chromatographic data by determining at least one data point in the graph of a set of chromatographic data according to a predetermined criteria. A set of deviations is calculated from the data point in each set of chromatographic data. A set of replicated data points is created wherein each replicate data point is calculated by combining each data point and a randomly selected deviation. Once the replicated data is created, statistical analysis may be performed on the set of replicate data points. The replication of data points uses random selection with replacement. The deviations may be calculated by a function of a random percentile number and a calculated standard deviation from a data point. A first and second derivative of the chromatograph may be calculated for each data point. The data points may further be smoothed.

### RELATED APPLICATIONS

This application claims the benefit of U.S. Provisional Patent Application No. 61/427,012 filed on Dec. 23, 2010, which is incorporated herein by reference.

### BACKGROUND

The invention relates generally to chromatographic processing software and, more particularly, to chromatographic peak detection software for laboratory use.

Liquid chromatography with mass spectrometric detection is a common technique used for chemical compound identification and quantification. It is used in a variety of settings including, but not restricted to, pharmaceutical and environmental laboratories. A chromatographic feature associated with each compound in the sample is known as a peak. The location of the peak in time is characteristic of the compound, while the area under the peak is a measure of its concentration. The data from a chromatograph instrument may be processed by a computer program which locates individual peaks and determines their areas. The resultant peak list is used for a variety of research, diagnostic, and regulatory applications.

Automatic computer identification of chromatographic peaks using existing software is problematic when the signal-to-noise ratio of the data is low and/or when multiple peaks overlap to form clusters. High-order derivatives may provide valuable information for assessing the number of underlying compounds under a given peak cluster. In addition, smoothing techniques may be used to properly compute the derivatives, because noise effects may be amplified when differences are calculated. For example, the Savitzky-Golay smoother may be applied in combination with the Durbin-Watson criterion to automate window size selection for removing noise with minimal impact on the information content. However, despite the existence of such sophisticated and statistically valid methods of peak detection, there are still many problems posed by current statistical methods of peak identification and detection, particularly with difficult data.

### SUMMARY OF THE INVENTION

An automated system and method are disclosed for the processing of chromatographic data with replicated data points based on statistical manipulation of original observed data. In one embodiment, the data is processed to minimize the noise in the observed data, to create a smoothed set of data. The smoothed data is subtracted from the actual data to provide a vector of noise values. Smoothed data points are replicated using random selection from the vector of noise values. The replicated data points provide additional data that is used in the bootstrap analysis, allowing valid statistics to be calculated from an original data set that would otherwise not necessarily provide valid statistics.

The statistical technique of bootstrapping is used to create pseudo replicate chromatograms. These replicates have the chromatographic noise randomly redistributed in such a way that its effect on the resulting calculated data points may be averaged. In one embodiment, a bootstrap is effected by first processing the chromatogram using an optimum smoothing filter. Then the smooth trace is subtracted from the raw chromatogram to create a vector of differences or deviations which, in the absence of distortion, is the noise. At this point a predetermined number of new items, e.g. 100 new noise vectors, are created by randomly selecting values, with replacement, from the difference or deviation vector. In turn, in this exemplary embodiment, the 100 noise vectors are added to the smoothed chromatogram to generate 100 pseudo replicate chromatograms.

In various embodiments, a series of numerical procedures may be realized in computer code for improving the current state of the art by providing substantially improved results for analysis of difficult data, for example data having clustered peaks and/or a low S/N ratio. Such data corresponds to actual measurements of samples of complex mixtures of chemicals and organic materials, and the chromatographs represent indications of the composition of such samples and characteristics of associated chemical and bio-chemical formulations.

One embodiment provides replication software that determines at least one data point in a graph created according to predetermined criteria for a set of chromatographic data, calculates a set of deviations from the at least one data point in each set of chromatographic data, and then calculates a set of replicated data points by combining a selected data point of chromatographic data and a randomly selected deviation. Finally, analysis software performs statistical analysis of the set of replicate data points.

In another embodiment, individual data points are used to create a “triple,” or three value vector, using the data value, its first derivative, and its second derivative. Once the individual triples are created, an iterative process of creating replicate data points continues until a sufficient number of triples are available for statistical analysis. Once the requisite sample size is observed and/or replicated, the data is then analyzed.

Further embodiments involve performing the selection of deviations with replacement. The deviations may be from a set of raw deviations from a calculated average, or they may be from a set of deviations from smoothed data points. Alternatively, the deviations may be created from a statistic based on the raw or smoothed data points, for example calculating a set of deviations by multiplying a random variable by the standard deviation of the data points. As a further refinement, a predetermined number of replicates may be created to form a first replicate data set which is then used to calculate a statistic, and then using that statistic to create a second set of replicates using the first replicate data set. Additional iterations may be performed, for example, to create a third set of replicates using the second replicate data set, and so forth, whereby deviations may be further developed. Theoretically, all the permutations of original data points and possible variations could be replicated, enabling the calculation of exact statistics of the original sample. However, for practical purposes the set of all permutations is typically subjected to a Monte-Carlo sampling of those permutations to provide approximate statistics for the original sample.

Another embodiment relates to a machine-readable program storage device for storing encoded instructions for various methods of creating data replicates according to the foregoing embodiments.

### BRIEF DESCRIPTION OF THE DRAWING FIGURES

The above mentioned and other features and objectives, and the manner of attaining them, will become more apparent and better understood by reference to the following description of embodiments taken in conjunction with the accompanying drawing figuress, wherein:

FIG. 1 is a schematic diagram of an exemplary network system in which various embodiments may be utilized;

FIG. 2 is a block diagram of an exemplary computing system (either a server or client, or both, as appropriate), that may include input devices (e.g., keyboard, mouse, touch screen, etc.) and output devices, hardware, network connections, one or more processors, and memory/storage for data and modules, and that may be utilized in conjunction with various embodiments;

FIGS. 3A-3B are graphic views of exemplary chromatographic data including derivative values;

FIGS. 4A-4C are graphic views of replicated chromatographic data including derivative values based on replicated data;

FIG. 4D is a chart view of exemplary replicated chromatographic data including derivative values based on replicated data;

FIG. 5 is a schematic diagram of an exemplary processing arrangement suitable for being utilized in various embodiments;

FIG. 6 is a schematic diagram of an exemplary processing arrangement suitable for being utilized in various embodiments; and

FIG. 7 is a flow chart diagram of an operation relating to the creation of replicates in an exemplary embodiment.

Corresponding reference characters indicate corresponding parts throughout the several views. Although the drawings represent exemplary embodiments, the drawings are not necessarily to scale and certain features may be exaggerated in order to better provide appropriate illustration and explanation. The flow charts and screen shots are also representative in nature, and actual embodiments may include further features or steps not shown in the drawings. Each exemplification set out herein illustrates an embodiment in one form, and such exemplifications are not to be construed as limiting the scope of the invention in any manner.

### DETAILED DESCRIPTION

The embodiments disclosed below are not intended to be exhaustive or limited to the precise forms disclosed in the following detailed description. Rather, the embodiments are chosen and described so that others skilled in the art may utilize their teachings.

The detailed descriptions which follow are presented in part in terms of algorithms and symbolic representations relating to operations within a computer memory that process data bits representing alphanumeric characters or other information. A computer generally includes a processor for executing instructions and memory for storing instructions and data. When a general purpose computer has a series of machine-encoded instructions stored in its memory, the computer operating on such encoded instructions may become a specific type of machine, namely a computer particularly configured to perform the operations prescribed by the series of instructions. Some of the instructions may be adapted to produce signals that control operation of other machines and thus may operate through those control signals to transform materials far removed from the computer itself. Mathematical and symbolic descriptions and representations of machine operations provide a means used by those skilled in the art of data processing arts for effectively conveying the substance of their work.

An algorithm is here, and generally, conceived to be a self-consistent method expressed as a finite list of instructions for implementing a function, such as performing a calculation in a sequence of steps leading to a desired result. Individual or collective steps may require physical manipulations of physical quantities. Usually, though not necessarily, these quantities may take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, labels, or the like, in reference to the physical items or manifestations in which such signals are embodied or expressed.

Some algorithms may use data structures for both inputting information and in various processes for producing a desired result. Data structures greatly facilitate data management in data processing systems, and are typically not accessible except through sophisticated software systems. Data structures do not generally include the information content of a memory; rather, they represent specific (e.g., electronic, magnetic) structural elements which impart to or manifest a physical organization on the information stored in memory. More than mere abstraction, the data structures are specific structural elements in memory which represent complex data accurately, such as by simultaneously data modeling the physical characteristics of related items, and which provide increased efficiency in computer operation.

Further, the manipulations performed are often referred-to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the disclosed operations include general purpose digital computers or other similar devices. Methods for operating a computer are distinguished from computational methods of the various embodiments. Such computational methods generally process electrical or other (e.g., mechanical, chemical) physical signals to generate physical manifestations or signals that correspond in a desired fashion. The computer may be operated using software modules, collections of signals stored on a media that represents a series of machine instructions which enable the computer processor to perform the machine instructions that implement algorithmic steps. Such machine instructions may be a low level computer code that a processor interprets to implement the instructions, or alternatively it may be a higher level coding that is interpreted to obtain the actual computer code of the instructions. A software module may also include a hardware component, whereby some aspects of the algorithm may be performed by the circuitry itself rather than by performing a calculation from a set of instructions.

An exemplary apparatus for performing these operations may be specifically constructed and dedicated for required purposes or it may comprise a general purpose computer that is selectively activated or reconfigured by a computer program stored in the computer. The algorithms presented herein are not inherently related to any particular computer or other apparatus unless otherwise noted. In some cases, computer programs may communicate or relate to other programs or equipment through signals configured by particular protocols that may or may not require specific hardware or programming for interaction. In particular, various general purpose machines may be used with programs written in accordance with the teachings herein, or specialized apparatus may be utilized. Appropriate structure for a variety of these machines will be apparent from the description below.

“Object-oriented” software and “object-oriented” operating systems are organized into “objects,” each comprising a block of computer instructions describing various procedures (“methods”) to be performed in response to “messages” sent to the object or in response to “events” which occur within the object. Such operations may include, for example, the manipulation of variables, the activation of an object by an external event, and the transmission of one or more messages to other objects.

In operation, messages are sent and received between objects for implementing certain functions and for conveying knowledge regarding how to carry out processes. Messages are generated in response to user instructions, for example, by a user activating an icon with a mouse pointer, thereby generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where other objects are not allowed access. One feature of an object-oriented system is inheritance. For example, an object for drawing a “circle” on a display may inherit functions and knowledge from another object for drawing a “shape” on a display.

A programmer may program in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, where the behavior of each component may be simulated by the methods of its corresponding object, and where the interactions between components may be simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of messages and responses may continue indefinitely or may come to an end when all messages have been responded to and no new messages are being sent. When modeling systems utilize an object-oriented language, a programmer is generally only required to think in terms of how each component of a modeled system responds to a stimulus and not in terms of a combination or sequence of operations to be performed in response to such stimulus. A combination or sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is typically not immediately apparent from a software listing, as might be the general case for sequentially organized programs. Nor is it easy to determine how an object-oriented program works through observation of the readily apparent manifestations of its operation. Most of the operations carried out by a computer in response to a program are “invisible” to an observer since only a relatively few steps in a program may produce an observable computer output.

In the following description, several terms have specialized meanings in the present context. The term “object” relates to a set of computer instructions and associated data which can be activated directly or indirectly by the user. The terms “windowing environment,” “running in windows,” and “object oriented operating system” are used to denote a computer user interface in which information is manipulated and displayed on a video display such as within bounded regions on a raster scanned video display. The terms “network,” “local area network,” “LAN,” “wide area network,” or “WAN” refer to two or more computers which are connected so that messages may be transmitted between the computers. In such computer networks, typically one or more computers operates as a “server,” a computer typically having one or more large storage devices such as hard disk drives and having communication hardware to operate peripheral devices such as printers or modems. Other computers, termed “workstations,” provide a user interface so that users of computer networks can access the network resources, such as shared data files, common peripheral devices, and inter-workstation communication. Users activate computer programs or network resources to create “processes” which may include both the general operation of the computer program along with specific operating characteristics determined by input variables and the operational environment. An agent (sometimes called an intelligent agent) is typically a process that gathers information or performs some other service without user intervention and on some regular schedule. An agent may utilize parameters provided by the user for searching locations either on the host machine or at some other point on a network, for gathering the information relevant to the purpose of the agent, and for presenting information to the user on a periodic basis.

The term “desktop” refers to a specific user interface which presents a menu or graphic display of objects with associated settings for the user associated with her use of the desktop. When the desktop accesses a network resource, which typically requires an application program to execute on the remote server, the desktop calls an Application Program Interface, or “API,” to allow the user to provide commands to the network resource and observe any output. The term “browser” refers to a program which is not necessarily apparent to the user, but which is responsible for transmitting messages between the desktop and the network server and for displaying and interacting with the network user. Browsers are typically designed to utilize a communications protocol for transmission of text and graphic information over a worldwide network of computers, namely the “World Wide Web” or simply the “Web.” Examples of browsers compatible with the present invention include the Internet Explorer program sold by Microsoft Corporation (Internet Explorer is a trademark of Microsoft Corporation), the Opera Browser program created by Opera Software ASA, and the Firefox browser program distributed by the Mozilla Foundation (Firefox is a registered trademark of the Mozilla Foundation), and others. Although the following description details various operations in terms of a graphic user interface of a browser, the present invention may be practiced with text based interfaces, with voice or visually activated interfaces having many of the functions of a graphic based browser, or by use of any appropriate input/output device.

Browsers may display information which is formatted in a Standard Generalized Markup Language (“SGML”) or a HyperText Markup Language (“HTML”), both being scripting languages which embed non-visual codes in a text document through the use of special ASCII text codes. Files in such formats may be easily transmitted across computer networks, including global information networks like the Internet, and these formats allow the browsers to display text, images, and play audio and video recordings. The Web utilizes these data file formats in conjunction with a communication protocol to transmit the information between servers and workstations. Browsers may also be programmed to display information provided in an eXtensible Markup Language (“XML”) file, with XML files being capable of use with several Document Type Definitions (“DTD”) and thus being more general in nature than SGML or HTML. An XML file may be analogized to an object, because the data and the style sheet formatting are typically separately contained (formatting may be thought of as including methods of displaying information; thus, an XML file has data and an associated method).

The terms “personal digital assistant” or “PDA,” generally refers to any handheld, mobile device that combines computing, telephone, fax, e-mail and networking features. The terms “wireless wide area network” or “WWAN” refers to a wireless network that serves as the medium for the transmission of data between a handheld device and a computer. The term “synchronization” includes the exchanging of information between a first device (e.g., a handheld device) and a second device (e.g., a desktop computer), either via wires or wirelessly. Synchronization typically ensures that the data on both devices are identical (at least at the time of synchronization).

In wireless wide area networks, communication may occur through the transmission of radio signals over analog, digital cellular, or personal communications service (“PCS”) networks. Signals may also be transmitted through microwaves and via other electromagnetic waves. Wireless data communication may take place across cellular systems using second generation technology such as code-division multiple access (“CDMA”), time division multiple access (“TDMA”), the Global System for Mobile Communications (“GSM”), Third Generation (wideband or “3G”), Fourth Generation (broadband or “4G”), personal digital cellular (“PDC”), and/or via packet-data technology over analog systems such as cellular digital packet data (“CDPD”) used on the Advance Mobile Phone Service (“AMPS”).

The terms “wireless application protocol” or “WAP” refers to a universal specification that facilitates the delivery and presentation of web-based data on handheld and mobile devices having small user interfaces. “Mobile Software” refers to a software operating system which allows application programs to be implemented on a mobile device such as a mobile telephone or PDA. Examples of Mobile Software are Java and Java ME (Java and JavaME are trademarks of Sun Microsystems, Inc. of Santa Clara, Calif.), BREW (BREW is a registered trademark of Qualcomm Incorporated of San Diego, Calif.), Windows Mobile (Windows is a registered trademark of Microsoft Corporation of Redmond, Wash.), Palm OS (Palm is a registered trademark of Palm, Inc. of Sunnyvale, Calif.), Symbian OS (Symbian is a registered trademark of Symbian Software Limited Corporation of London, United Kingdom), ANDROID OS (ANDROID is a registered trademark of Google, Inc. of Mountain View, Calif.), and iPhone OS (iPhone is a registered trademark of Apple, Inc. of Cupertino, Calif.). “Mobile Apps” refers to software programs written for execution with Mobile Software.

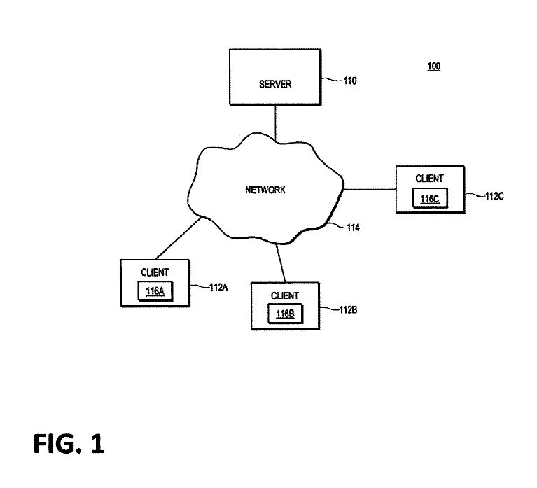

FIG. 1 is a high-level block diagram of a computing environment 100 according to an exemplary embodiment. Server 110 and three clients 112 are connected by network 114. Only three clients 112 are shown in order to simplify and clarify the description. Embodiments of the computing environment 100 may have thousands or millions of clients 112 connected to network 114, for example on the Internet. Users may operate software 116 as one of clients 112, to both send and receive messages over network 114 via server 110 and its associated communications equipment and software (not shown).

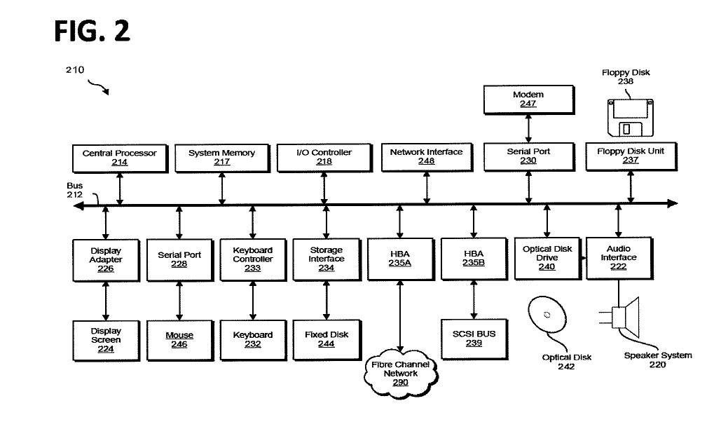

FIG. 2 depicts a block diagram of a computer system 210 suitable for implementing server 110 or client 112. Computer system 210 includes bus 212 which interconnects major subsystems of computer system 210, such as central processor 214, system memory 217 (typically RAM, but which may also include ROM, flash RAM, or the like), input/output controller 218, external audio devices, such as speaker system 220 connected via audio output interface 222, external devices, such as display screen 224 connected via display adapter 226, serial ports 228 and 230, keyboard 232 (interfaced with keyboard controller 233), storage interface 234, disk drive 237 operative to receive floppy disk 238, host bus adapter (HBA) interface card 235A operative to connect with fibre channel network 290, host bus adapter (HBA) interface card 235B operative to connect to SCSI bus 239, optical disk drive 240 operative to receive optical disk 242, and any other appropriate equipment or media. Also included are mouse 246 (or other point-and-click device, coupled to bus 212 via serial port 228), modem 247 (coupled to bus 212 via serial port 230), and network interface 248 (coupled directly to bus 212).

Bus 212 allows data communication between central processor 214 and system memory 217, which may include read-only memory (ROM) or flash memory (neither shown), and random access memory (RAM) (not shown), as previously noted. ROM or flash memory may contain, among other software code, a Basic Input-Output system (BIOS) which controls basic hardware operation such as interaction with peripheral components. Applications resident with computer system 210 are generally stored on and accessed via computer readable media, such as on hard disk drives (e.g., fixed disk 244), optical drives (e.g., optical drive 240), floppy disk units 237, or on other storage medium. Additionally, applications may be in the form of electronic signals modulated in accordance with a given application and data communication technology, when accessed via network modem 247 or interface 248 or other telecommunications equipment (not shown).

Storage interface 234, as with other storage interfaces of computer system 210, may connect to standard computer readable media for storage and/or retrieval of information, such as fixed disk drive 244. Fixed disk drive 244 may be part of computer system 210 or it may be separately accessed through other interface systems. Modem 247 may provide direct connection to remote servers via a telephone link or to the Internet via an Internet service provider (ISP) (not shown). Network interface 248 may provide direct connection to remote servers via a direct network link to the Internet, such as with a POP (point of presence) application. Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 2 need not be present to implement a practice according to the present disclosure. Devices and subsystems may be interconnected in different ways from that shown in FIG. 2. Operation of a computer system such as that shown in FIG. 2 is readily known in the art and is not discussed in detail in this application. Software source and/or object codes for implementing the present disclosure may be stored in computer-readable storage media such as one or more of system memory 217, fixed disk 244, optical disk 242, and floppy disk 238. The operating system provided on computer system 210 may be a variety or version of either MS-DOS® (MS-DOS is a registered trademark of Microsoft Corporation of Redmond, Wash.), WINDOWS® (WINDOWS is a registered trademark of Microsoft Corporation of Redmond, Wash.), OS/2® (OS/2 is a registered trademark of International Business Machines Corporation of Armonk, N.Y.), UNIX® (UNIX is a registered trademark of X/Open Company Limited of Reading, United Kingdom), Linux® (Linux is a registered trademark of Linus Torvalds of Portland, Oreg.), or other known or developed operating system.

Moreover, regarding the signals described herein, those skilled in the art recognize that a signal may be directly transmitted from a first block to a second block, or a signal may be modified (e.g., amplified, attenuated, delayed, latched, buffered, inverted, filtered, or otherwise modified) between blocks. Although signals may be characterized as being transmitted from one block to the next, various embodiments of the present disclosure may include the use of modified signals in place of such directly transmitted signals so long as the informational and/or functional aspect of the signal is transmitted between blocks. To some extent, a signal being input to a second block may be conceptualized as being a second signal derived from a first signal being output from a first block, due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

Computer 210 may have multiple data processing software programs capable of refining raw chromatographic data and/or analyzing chromatographic data for quality assurance or regulatory compliance purposes. In such software, features such as data smoothing, peak selection or peak picking, normalization, and other techniques may be employed to provide data more suitable for analysis. According to various embodiments, such software may include a bootstrap module adapted to replicate data having a small sample size so that statistical techniques may be validly applied to the collected data.

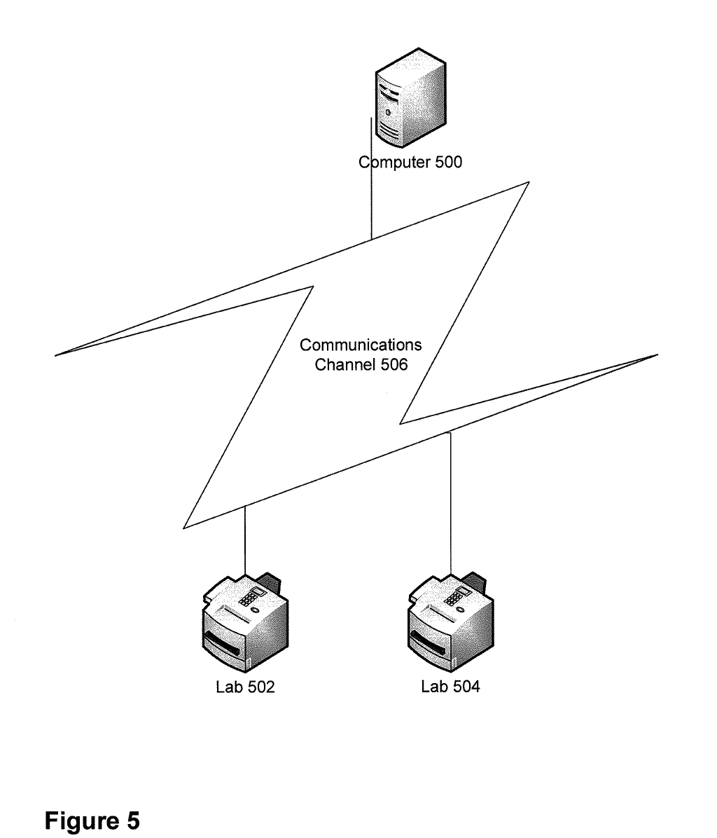

FIG. 5 depicts an exemplary architecture where a lab may have computing device 500 and one or more chromatograph lab devices 502, 504 in communication with computer 500 through channel 506, where computing device 500 obtains sample data from chromatograph devices 502, 504, performs data gathering steps as detailed below, and analyzes the data.

Bootstrapping as used in the present disclosure generally involves augmenting a statistically small sample with data values derived from a random sample (with replacement) from the original data set. While the present discussion of bootstrapping relates to a specific model of chromatographic data, such bootstrapping may be applied to other types of sample data. The bootstrapping disclosed herein is adapted for use with chromatographic data because of its compatibility with the underlying model of such chromatographic data. The term chromatographic peak refers to the point or section of a chromatographic chart that includes a local maximum or minimum. The term smoothed data relates to raw data that has been processed or refined by a predetermined algorithm to eliminate or minimize noise in the sample data. The term synthetic data relates to data that is not a result of direct observation or measurement, while the term replicate data relates to data that is related to observed or measured data and that is subject to a random function for augmenting a given set of observed or measured data.

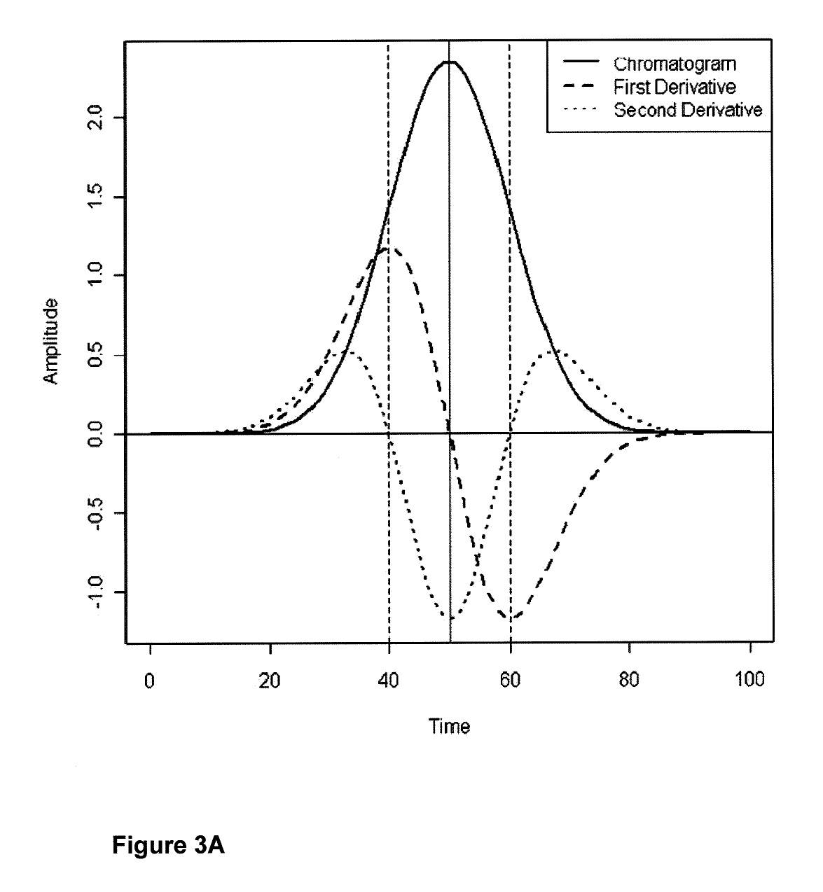

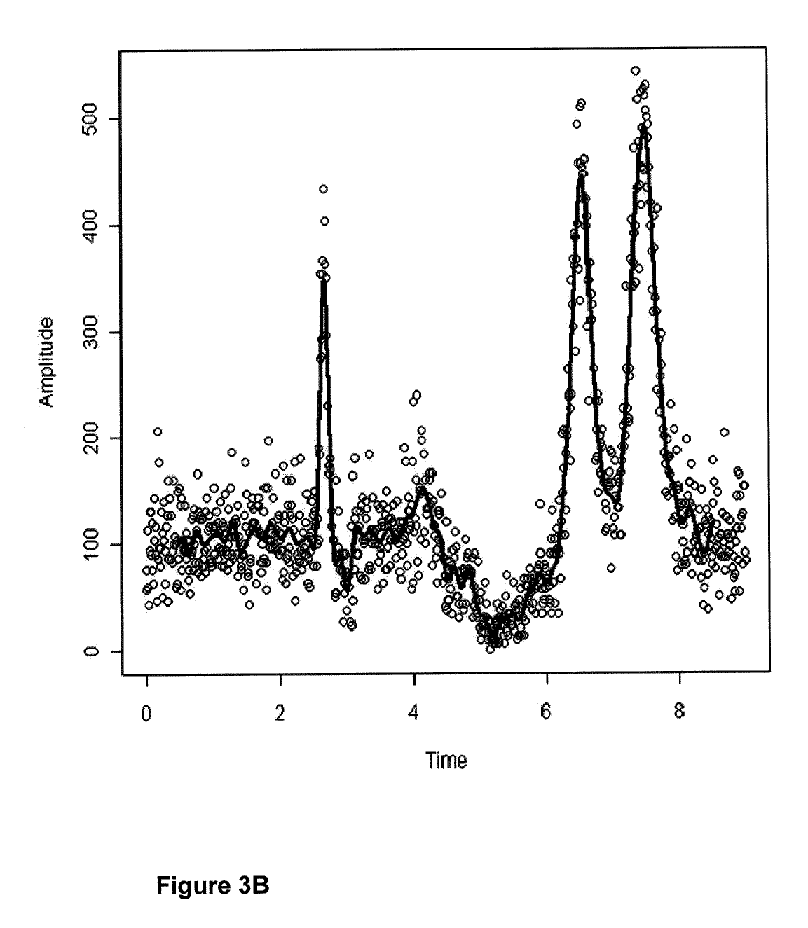

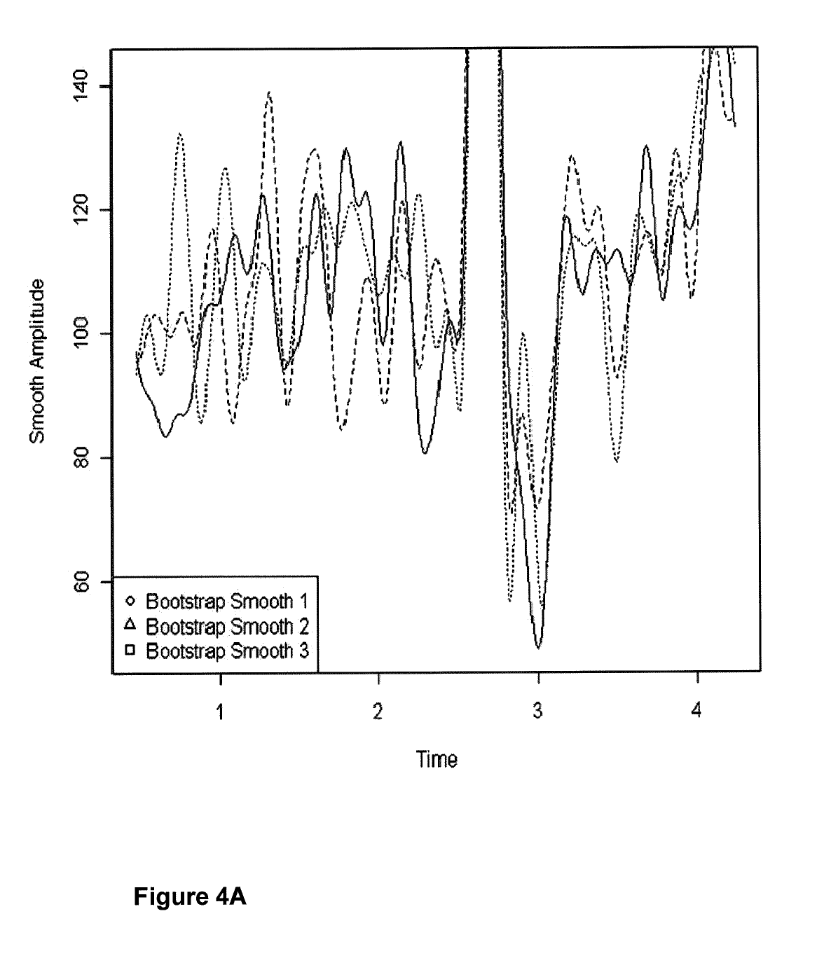

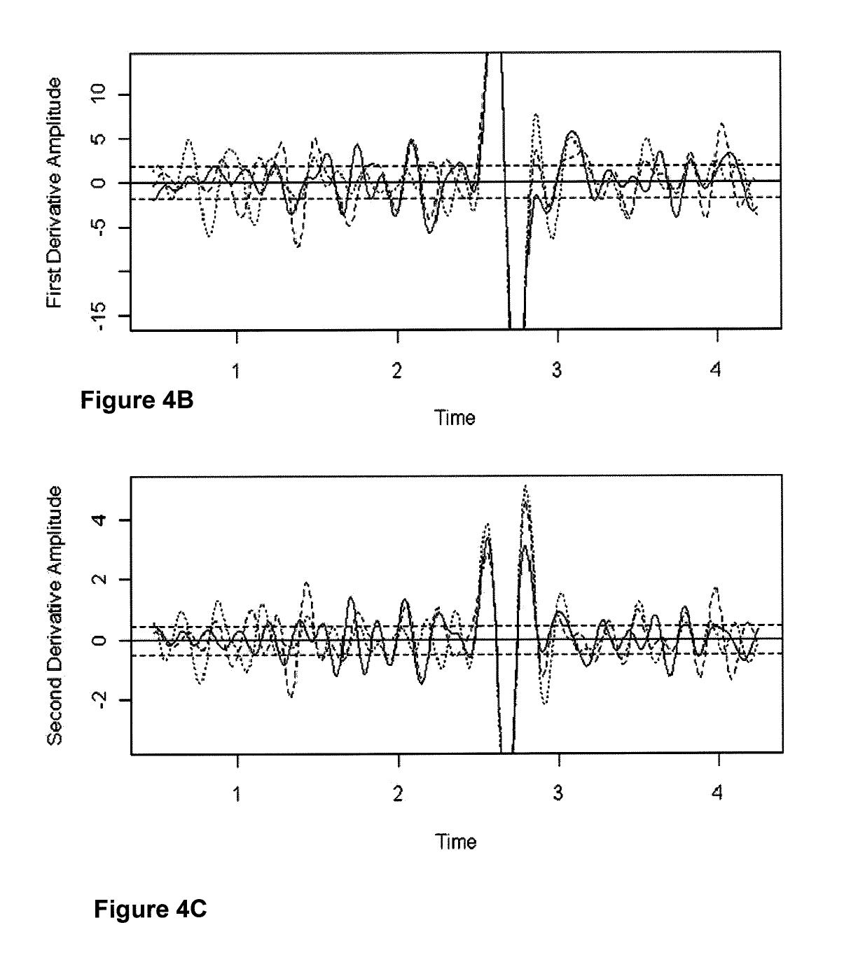

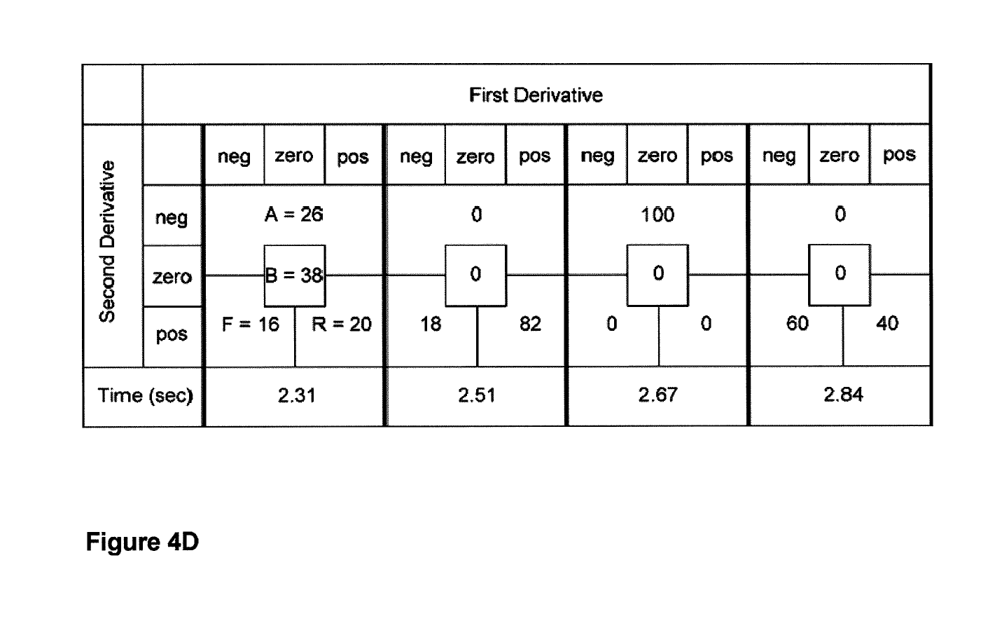

Exemplary chromatograms are illustrated in FIGS. 3A-3B, with FIGS. 4A-4D further including replicated data in such chromatograms.

FIG. 3A shows, for a noise-free curve, how derivatives may be used to identify and distinguish those portions of a chromatogram that would be described as baseline (from time 0 to time 10, and from time 90 to time 100) and those portions associated with a peak. In this exemplary synthetic Gaussian-shaped peak, the first and second derivatives are shown. The two vertical dashed lines are peak inflection points. The derivatives are scaled to improve graphic clarity. The baseline is recognized at data points where both the first and second derivatives are approximately zero. A peak has three recognizable regions. The rising region is recognized as running from the end of the baseline to the first inflection point. For this region, both the first and second derivatives are positive. The falling region is recognized as running from the second inflection point to the onset of the baseline. For this region the first derivative is negative and the second derivative is positive. The apex region is recognized solely by the second derivative being negative.

FIG. 3B shows an actual chromatogram that, without bootstrapping, resisted automatic peak detection because of the extreme level of random electronic noise. As shown, raw data is represented by points and the original smoothed chromatogram is represented by a solid line. When bootstrapping was utilized, all three peaks known to be in the sample were identified—those at 2.67, 6.55 and 7.54 seconds. The area under each peak was also computed for quantitative analysis.

FIG. 4A is an exemplary illustration of three of the smoothed, bootstrap chromatograms, in an exemplary case having 100 data sets, where a portion of three replicate chromatograms were created by bootstrapping the noise of FIG. 3B and re-smoothing. The illustrated y-axis is truncated to emphasize the extent of baseline noise, where the same level of noise appears across the peak centered at 2.67 seconds. To obtain the bootstrap chromatograms, the raw data in FIG. 3B was subtracted from the smoothed data. This created a vector of noise that was bootstrapped and added to the smoothed curve. The result was synthetically produced chromatograms with the original noise randomly redistributed, for example 100 chromatograms. These synthetic chromatograms were then smoothed using the same filter that obtained the data in FIG. 3B. Note how at any point in time the smoothed amplitude varies randomly due to the bootstrapped noise.

FIG. 4B shows three of the derivative traces for a bootstrap chromatogram filtered by a first derivative filter and FIG. 4C shows three of the derivative traces for a bootstrap chromatogram filtered by a second derivative filter, showing the effect of noise on bootstrapped first and second derivatives. The two horizontal traces are ±σ for the first derivative, and 0.892σ and −σ for the second derivative. To obtain the traces, the same procedure was used as that for the smoothed traces in FIG. 4A, except that traces in FIG. 4B were generated using a first derivative filter, and those in FIG. 4C using a second derivative filter. In both graphs the dashed horizontal lines are (sigma) limits used to recognize baseline regions. At any point in time, when both the first and second derivatives fall within these limits the point is considered part of baseline region. The limits are not used to identify rising, apex and falling portions of a peak. These latter regions are identified by derivatives greater than or less than zero. The second derivative limits are asymmetric due to the functional form of the second derivative.

FIG. 4D is a chart illustrating how the bootstrap distribution of derivatives is used to classify data points as belonging to the baseline or to the rising, apex and falling regions of a peak. Derivative distributions for baseline (B), rising (R), apex (A) and falling (F) portions are provided for the several chromatograms, for example using 100 data sets. The numeric classifications are negative (neg, derivative <0), positive (pos, derivative >0), or zero (−limit <derivative <+limit) The result for 2.31 seconds clearly shows how the distribution helps identify this data point as baseline. Note that only the baseline uses derivatives falling within the limits (statistically indistinguishable from zero). The regions labeled A, B, F and R have derivative relationships as described in the preceding paragraph. Consider the distribution of regions for 2.31 seconds. For a run of multiple duplicate chromatograms, for example 100 chromatograms, if each chromatogram is processed individually without bootstrapping, ˜62% would have that time point labeled incorrectly. Thus, bootstrapping allows probabilistic assignments without adding the cost of running replicates.

Originally observed or measured data points are first smoothed to eliminate most noise in the measured values, (see, e.g., FIG. 3B). In an exemplary embodiment involving the detection of local peaks in chromatographic data, each smoothed data point is transformed into a data triple including both the original smoothed value, and two additional calculated values representing the first and second derivatives for the smoothed data point (such derivatives being calculated on the basis of the set of smoothed data points).

In various embodiments, an appropriate bootstrap replication is created by first obtaining mean values of the observed or measured data, and then obtaining a set of deviations from the mean by subtracting the mean value from the observed or measured data. The resulting set of deviations is subject to random sampling, with replacement, to add back random noise to original smoothed data to thereby create the replicate data points for replicate chromatographs. Once a replicate chromatograph is created, the derivative values may then be calculated to create a replicate chromatograph of such triples.

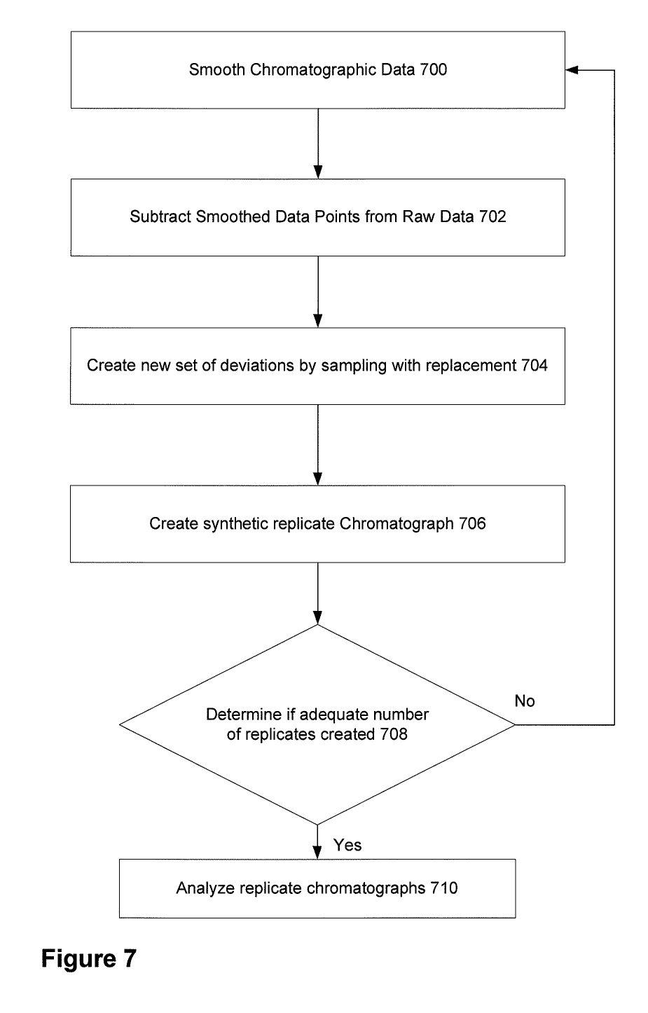

Bootstrapped chromatograms may be created using the following procedure, (see, e.g., FIG. 7). First the chromatographic data are smoothed in step 700. Then the smoothed data set is subtracted from the original to create a set of deviations in step 702. Next, a new set of deviations is randomly selected (with replacement) from the original deviations in step 704. Finally, the new deviations are added to the smoothed chromatogram to generate a synthetic, replicate chromatogram in step 706. This procedure is repeated until a predetermined number (e.g., 100) of synthetic replicates are generated, as determined in step 708. Once complete, the entire data set including replicates may be analyzed in step 710 as described above. Alternatively, this process may be iterated by starting with actual data, creating replicates to generate a set of actual and replicate data, and then the process may be repeated starting with that set of actual and replicate data to create further replicate data.

In another embodiment, bootstrapped chromatographs are created using a similar procedure. In distinction from the previously discussed creation of a set of deviations, in this embodiment the statistical standard deviation of each data point is calculated. Synthetic replicates are generated in a Monte-Carlo fashion, where a random number generator is used to randomly generate a percentile number (either positive or negative), and a randomly selected original data value is combined with a value which is a function of the randomly generated percentile number and the standard deviation. This process typically determines the number of standard deviations from the percentile (e.g., a 67 percentile would be about 1 standard deviation, a 95 percentile would be about 2 standard deviations, etc.) and then multiplies the number of standard deviations by the value of the standard deviation and combines that product to create the synthetic data point. Such bootstrap data makes it easier to smooth the data for smaller data sets.

In another embodiment, entire chromatograms may be replicated. However, this embodiment uses much more computational resources than the replication of data points within a chromatograph. As computational resources become more efficient and powerful, such replication of entire chromatographs may be the most efficient way to perform bootstrap replication on a small set of data. When costs of computational resources are high, such bootstrap replication of entire chromatographs may not be economically practical. By using the technique of bootstrapping to generate synthetic data, such synthetic data may be used to create surrogate chromatograph replicates.

In one embodiment, each of the synthetic chromatograms is processed by digital filters to generate individual sets of triples. In an exemplary embodiment, such triples are abstracted by associating a grammar with particular combinations of values for each triple, wherein each grammar is associated with a particular chromatogram graph characteristic. With the translation of each triple to a corresponding grammar element, the comparison of chromatograms may be simplified by comparing grammars, which is a much less computation-intensive activity. When the bootstrapped replication approach described above is combined with symbolic representation of chromatograms through such grammars, the result is a high performance algorithm capable of correctly locating peaks in a wide range of chromatographic data. The method is particularly rugged toward noise, and lends itself to automation.

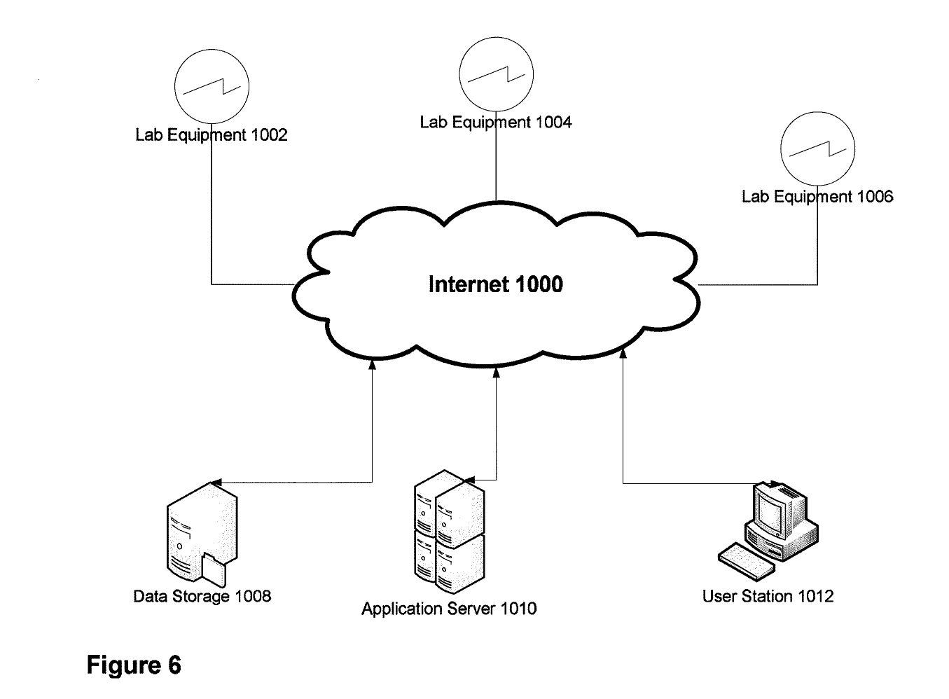

A further exemplary embodiment is depicted in FIG. 6. The illustrated hosted application embodiment uses Internet 1000 as a communication channel for various lab equipment 1002, 1004, and 1006. Lab equipment 1002, 1004, and 1006 may represent separate machines at a single location, or each may represent a location having one or several machines, all such machines generating experimental data such as chromatographic data. Such data is sent via Internet 1000 to data storage device 1008. Although shown as a single data repository, data storage device 1008 may be configured as several storage systems which coordinate storage via Internet 1000. Software modules (not shown) may be provided on application server 1010 to perform a variety of processing functions on experimental data stored within data storage device 1008. A user may operate user station 1012 via Internet 1000 to invoke software modules on application server 1010 to remotely activate such modules that operate on experimental data stored on data storage device 1008, with the option of saving the results on data storage device 1008 for later remote access or alternatively allowing for the saving of the results on user station 1012 for further use beyond the confines of application server 1010 or data storage device 1008.

The exemplary statistical tools described herein are well suited for an automated system and method of peak detection. Such methods allow for the processing of chromatographic data with replicated data points based on statistical manipulation of original observed data. The data is processed to minimize the noise in the observed data using statistical tools. The data may also be abstracted to a grammar which makes comparison among divergent observed data much easier and more reliable. In addition to minimizing noise, statistical techniques may be used to create replicate data to enhance data analysis when the amount of original data is less than statistically desirable. The replicated data points provide additional data points that may be used in the bootstrap analysis. A hosted application embodiment allows for the coordination of multiple machines and/or locations for a relatively uniform determination of peak detection and analysis.

While embodiments have been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A computer for analyzing chromatographic data, said computer comprising:
a processor;
memory coupled to said processor and configured to store computer instructions and computer data;
replication software, said replication software capable of enabling said processor to perform the following steps:
determining at least one data point in the graph of a set of chromatographic data according to a predetermined criteria;
calculating a set of deviations from said at least one data point in each of said set of chromatographic data;
calculating a set of replicated data points by creating a plurality of replicate data points, each said replicate data point calculated by combining a randomly selected one of said data points of chromatographic data and a randomly selected one of said set of deviations; and
analysis software for enabling said processor to perform statistical analysis of said set of replicate data points.

2. The computer of claim 1 wherein said replication software uses random selection with replacement.

3. The computer of claim 1 wherein said replication software creates deviations by a function of a random percentile number and a calculated standard deviation from said at least one data point.

4. The computer of claim 1 wherein said replication software includes a module for calculating a first derivative of the chromatograph for said at least one data point.

5. The computer of claim 1 wherein said replication software includes a module for calculating a second derivative of the chromatograph for said at least one data point.

6. The computer of claim 1 wherein said replication software includes a smoothing module for smoothing said at least one data point.

7. A method of using a computer to analyze chromatographic data, said method comprising the steps of:
determining at least one data point in the graph of a set of chromatographic data according to a predetermined criteria;
calculating a set of deviations from said at least one data point in each of said set of chromatographic data;
calculating a set of replicated data points by creating a plurality of replicate data points, each said replicate data point calculated by combining a randomly selected one of said data points of chromatographic data and a randomly selected one of said set of deviations; and
performing statistical analysis of said set of replicate data points.

8. The method of claim 7 wherein said step of calculating a set of replicated data points uses random selection with replacement.

9. The method of claim 7 wherein said step of calculating a set of deviations creates deviations by a function of a random percentile number and a calculated standard deviation from said at least one data point.

10. The method of claim 7 wherein said step of determining further includes calculating a first derivative of the chromatograph for said at least one data point.

11. The method of claim 7 wherein said step of determining further includes calculating a second derivative of the chromatograph for said at least one data point.

12. The method of claim 7 wherein said determining step further includes smoothing said at least one data point.

13. A machine-readable program storage device for storing encoded instructions for a method of analyzing chromatographic data, said method comprising the steps of:
determining at least one data point in the graph of a set of chromatographic data according to a predetermined criteria;
calculating a set of deviations from said at least one data point in each of said set of chromatographic data;
calculating a set of replicated data points by creating a plurality of replicate data points, each said replicate data point calculated by combining a randomly selected one of said data points of chromatographic data and a randomly selected one of said set of deviations; and
performing statistical analysis of said set of replicate data points.

14. The machine-readable program storage device of claim 13 wherein said method includes said step of calculating a set of replicated data points uses random selection with replacement.

15. The machine-readable program storage device of claim 13 wherein said method includes calculating a set of deviations creates deviations by a function of a random percentile number and a calculated standard deviation from said at least one data point.

16. The machine-readable program storage device of claim 13 wherein said method includes calculating a first derivative of the chromatograph for said at least one data point.

17. The machine-readable program storage device of claim 13 wherein said method includes calculating a second derivative of the chromatograph for said at least one data point.

18. The machine-readable program storage device of claim 13 wherein said method includes smoothing said at least one data point.
